(19) United States
(12) Patent Application Publication
(10) Pub. No.: US 2006/0209818 A1
(43) Pub. Date: Sep. 21, 2006

(54) Methods and devices for preventing ARP cache poisoning

(76) Inventor: Jimmy Ray Purser, Pleasant Prairie, WI (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/084,441

(22) Filed: Mar. 18, 2005

(51) Int. Cl. H04L 12/28

(52) U.S. Cl. 370/389

(57) ABSTRACT

Methods of processing an address resolution protocol (ARP) response in connection with a data control switch are presented including: receiving an ARP response, the ARP response having an ARP response MAC address and a corresponding ARP response IP address; and dropping the ARP response when: the ARP response MAC address matches any of a plurality of ARP entry MAC addresses residing in an ARP table, and the corresponding ARP response IP address does not match a corresponding ARP entry IP address. In some embodiments, methods further include: creating an ARP entry corresponding to the ARP response in the ARP table when: the ARP response MAC address does not match any of the plurality of ARP entry MAC addresses.

### BACKGROUND OF THE INVENTION

In modern technological society, the rapid dissemination of timely data has become a paramount concern. Higher demand of quality data streams has fueled ever-evolving technology in both software and hardware. The resulting increase in connectivity has further resulted in a commensurate increased need for higher levels of security to protect data not intended for general consumption. Competing interests of high connectivity over secure data continues to influence progress made in information technologies.

Robust, hardened security generally restricts freedom of movement, which is contrary to at least one aim of technological growth that is to enhance freedom of movement. Movement, in the information world, is a metaphor for connectivity; that is the ability to define data sharing relationships and then exploit those relationships. In balancing the competing interests of security over freedom with respect to information movement, a security designer must, at some levels, accept less security in the interest of efficient data transfer. In the same way, an access designer must accept more security to protect data stores from outside attack at the expense of more efficient data sharing methodologies.

At the interface of these competing imperatives lay the targets of network attackers. One such target is the address resolution protocol (ARP). ARP is a network layer protocol used to convert an IP address into a physical address, such as a media access control (MAC) address. For example, a host wishing to obtain a physical address broadcasts an ARP request onto a TCP/IP network. A host on the network that has the MAC address in the request then replies with its physical hardware address. Thus, ARP allows for access to a particular client in a network resulting in data sharing efficiencies. However, this efficiency is not without risk.

One example security risk in switched networks today is known as ARP Spoofing. ARP spoofing allows an unauthorized user to access data in a switched network by poisoning the ARP cache of a network member. For example, when an Ethernet frame (i.e. data packet) is broadcast from one machine on a LAN to another machine on the same LAN, a 48-bit MAC address contained in the frame may be used to determine the interface or port to which the frame is directed. MAC addresses and their associated destinations are typically held in an ARP table. Unfortunately, in current methods, device drivers that make those determinations based on MAC addresses do not distinguish between a legitimate MAC address all ready existing on the network and a counterfeit MAC address. Thus, a rogue machine broadcasting a counterfeit MAC address may, in effect, assume the identity of a legitimate machine having a legitimate MAC address and therefore, receive data intended for the legitimate machine.

Further compounding the problem is that the most recent ARP response from any source is generally accepted as the “correct” entry in an ARP table. Thus, a rogue machine may misdirect data intended for a legitimate machine by simply sending a counterfeit ARP response later in time than a legitimate ARP response, or may simply flood the network with gratuitous counterfeit ARP responses in order to overcome any possible legitimate ARP responses. Thus, a network attacker may trick a device driver into sending data packets to an attacking rogue machine by poisoning the ARP with counterfeit entries generated by the attacker. In light of the foregoing, methods and devices for preventing ARP cache poisoning are presented herein.

### SUMMARY OF INVENTION

Methods of processing an address resolution protocol (ARP) response in connection with a data control switch are presented including: receiving an ARP response, the ARP response having an ARP response MAC address and a corresponding ARP response IP address; and dropping the ARP response when: the ARP response MAC address matches any of a plurality of ARP entry MAC addresses residing in an ARP table, and the corresponding ARP response IP address does not match a corresponding ARP entry IP address. In some embodiments, methods further include: creating an ARP entry corresponding to the ARP response in the ARP table when: the ARP response MAC address does not match any of the plurality of ARP entry MAC addresses. In some embodiments, methods further include: processing the ARP response when: the ARP response MAC address matches any of the plurality of ARP entry MAC address, and the corresponding ARP response IP address matches the corresponding ARP entry IP address.

In other embodiments, methods of controlling a network switch are presented including: receiving an ARP response, the ARP response having an ARP response MAC address and a corresponding ARP response IP address; and dropping the ARP response when: the ARP response MAC address matches any of a plurality of ARP entry MAC addresses residing in an ARP table, and the corresponding ARP response IP address does not match a corresponding ARP entry IP address. In some embodiments, methods further include: creating an ARP entry corresponding to the ARP response in the ARP table when: the ARP response MAC address does not match any of the plurality of ARP entry MAC addresses. In some embodiments, methods further include: processing the ARP response when: the ARP response MAC address matches any of the plurality of ARP entry MAC address, and the corresponding ARP response IP address matches the corresponding ARP entry IP address.

In other embodiments, a security enhanced network switch device is presented including: a memory component comprising at least an ARP table for storing a plurality of ARP entries each ARP entry having an ARP entry media access control (MAC) address and a corresponding ARP entry internet protocol (IP) address; and an address resolution protocol (ARP) component for examining an ARP response frame, the ARP response frame having an ARP response address and a corresponding ARP response IP address. In some embodiments, the ARP component may be configured to reject the ARP response frame when: the ARP response MAC address matches the ARP entry MAC address; and the corresponding ARP response IP address does not match the corresponding ARP entry IP address. In some embodiments, the ARP component may be further configured to process the ARP response frame when: the ARP response MAC address matches the ARP entry MAC address; and the corresponding ARP response IP address matches the corresponding ARP entry IP address. In some embodiments, the ARP component may be further configured to create a new ARP entry corresponding to the ARP response frame in the ARP table when: the ARP response MAC address does not match the ARP entry MAC address.

In other embodiments, a computer program product for use in conjunction with a computer system for processing an address resolution protocol (ARP) response in connection with a data control switch is presented, the computer program product comprising a computer readable storage medium and a computer program mechanism embedded therein, the computer program mechanism including: instructions for receiving an ARP response, the ARP response having an ARP response MAC address and a corresponding ARP response IP address; and instructions for dropping the ARP response when: the ARP response MAC address matches any of a plurality of ARP entry MAC addresses residing in an ARP table, and the corresponding ARP response IP address does not match a corresponding ARP entry IP address. In some embodiments, the computer program product further includes: instructions for creating an ARP entry corresponding to the ARP response in the ARP table when: the ARP response MAC address does not match any of the plurality of ARP entry MAC addresses. In some embodiments, the computer program product further includes: instructions for processing the ARP response when: the ARP response MAC address matches any of the plurality of ARP entry MAC address, and the corresponding ARP response IP address matches the corresponding ARP entry IP address.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an overview of a packet switched network in accordance with an embodiment of the present invention;

FIG. 2 is an overview of a Man-in-the-Middle attack of a packet switched network in accordance with an embodiment of the present invention; and

FIG. 3 is a diagrammatic flowchart of a method of ARP examination in accordance with an embodiment of the present invention.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

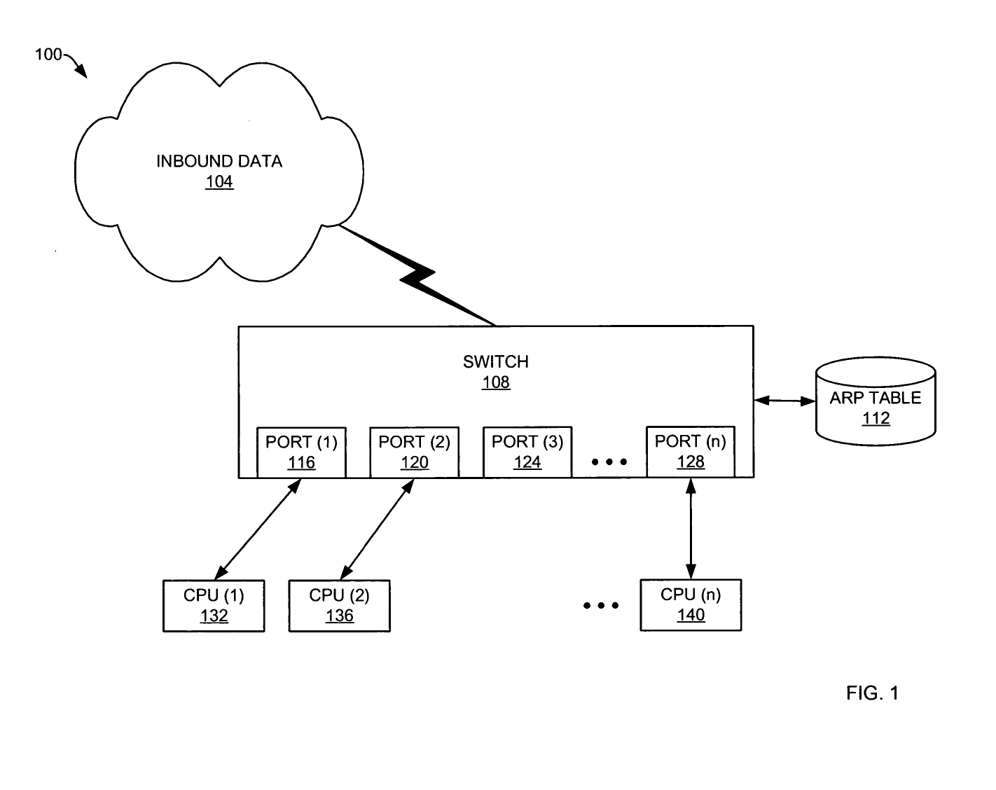

Turning to FIG. 1, FIG. 1 is an overview of a packet switched network 100 in accordance with an embodiment of the present invention. Inbound data 104 may be received by a network switch 108. Inbound data may originate from any of a number of sources as can be appreciated by one skilled in the art. Inbound data may originate from, for example, a node, a network server, a switch, a gateway, a router, a hub, or any other source known in the art. Switch 108 may be configured with any number of ports 116-128. Ports may be used to connect a switch with a device. In one example, a CPU's 132-136 may be connected with switch 108. CPU's and other devices may be connected with switch 108 without limitation. Further, CPU's and other devices may receive and send data through switch 108. In one embodiment, of the present invention, an address resolution protocol (ARP) response may be received by switch 108.

Switch 108 may also be configured with an ARP table 112. An ARP table may be populated with any number of ARP entries. ARP entries contain information related to port configuration on a switch. For example, inbound data intended for CPU 136 may be received by switch 108. Switch 108 may then consult ARP table 112. In some embodiments, ARP table 112 contains an ARP entry that designates port 120 as a port corresponding to CPU 136. In that example, switch 108 would then route inbound data intended for CPU 136 to port 120. In other embodiments, ARP table 112 may not contain an ARP entry designating a port for a corresponding DEVICE. Further, in that example, an ARP request may be issued by switch 108. An ARP request queries devices connected with a switch to find an appropriate receiving device. If an appropriate device is found, the found device may then issue an ARP response to switch 108. Switch 108 may then route inbound data to an appropriate port corresponding to the responding DEVICE. In some examples, switch 108 may subsequently modify ARP table 112 to contain an ARP entry for the responding device based on the device's ARP response.

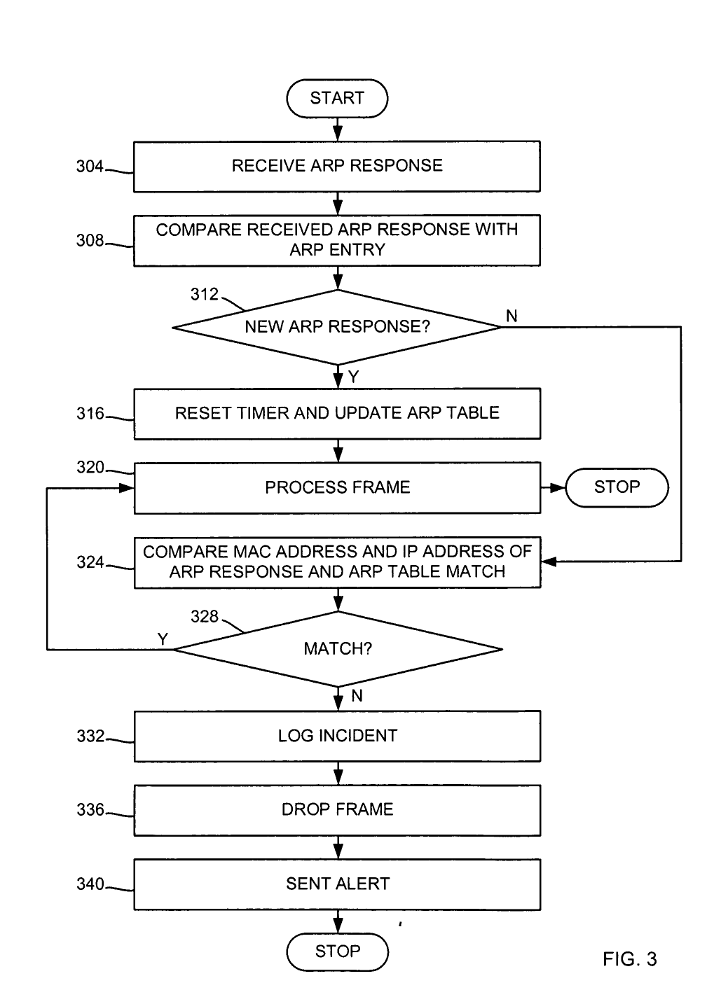

In still other embodiments, ARP table 112 may be periodically updated such that “old” ARP responses are timed out and “new” ARP responses are entered into a table. Typically, an ARP response includes a media access control (MAC) addresses. MAC addresses are well known in the art. An ARP response may also include an IP address of a responding device. In some embodiments, an ARP response having a MAC address and an IP address may be compared with an ARP entry having a MAC address and an IP address in an ARP table to determine whether a match exists between the two. Methods of comparing an ARP response to an ARP entry are discussed in further detail below for FIG. 3.

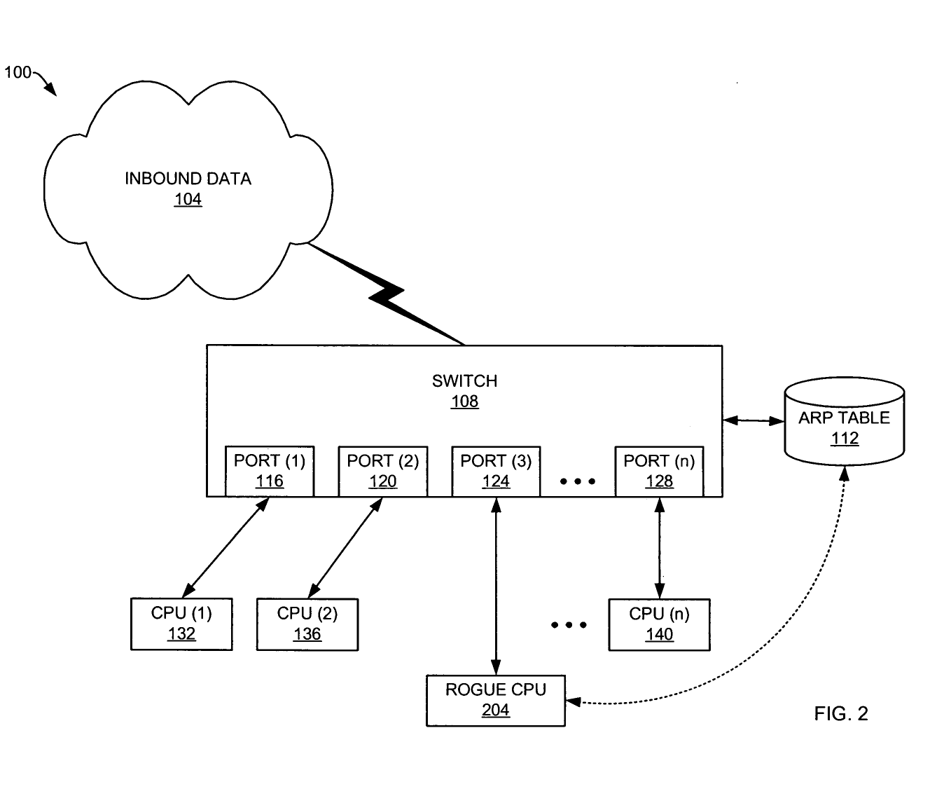

Turning to FIG. 2, FIG. 2 is an overview of a Man-in-the-Middle attack of a packet switched network in accordance with an embodiment of the present invention. In this illustration, a rogue CPU 204 is connected with switch 108 through port 124. In a typical Man-in-the-Middle attack, rogue CPU 204 may send a counterfeit ARP response in response to a legitimate ARP request. The basis of the attack exploits a known weakness in ARP—that is, that ARP cannot distinguish between a counterfeit MAC address and a legitimate MAC address. For example, a rogue DEVICE may issue a counterfeit ARP response that imitates a legitimate MAC address of a legitimate CPU 136 on switch 108. Thus, legitimate CPU 136 may, in response to an ARP request, issue a legitimate ARP response that includes a MAC address of 08-00-DE-AD-BE-EF. If rogue CPU 204 issues a counterfeit ARP response having a counterfeit MAC address (i.e. 08-00-DE-AD-BE-EF) later in time than legitimate CPU 136, then switch 108 will assume that the later received counterfeit ARP address is legitimate and subsequently configure port 124 to receive packets for rogue CPU 204 originally intended for CPU 136. Rogue CPU 204 may then relay packets to port 120 so that CPU 136 does not experience a disruption in network services. Rogue CPU 204 may then monitor data streams to and from CPU 136 without detection. Embodiments of the present invention are intended to prevent these and other similar attacks.

Referring to FIG. 3, FIG. 3 is a diagrammatic flowchart of a method of ARP examination in accordance with an embodiment of the present invention. At a first step 304, an ARP response is received by a switch such as, for example, switch 108 (see FIGS. 1-2). As noted above, an ARP response is issued in response to an ARP request to determine where data should be routed. At a next step 308, an ARP response received by a switch may be compared with a corresponding ARP entry residing in a switch ARP table. An ARP table may be populated with ARP entries that associate a port with a legitimate device having a legitimate MAC address. Further, a legitimate IP address corresponding to a legitimate device may also comprise a portion of an ARP entry.

If an ARP response does not have a corresponding ARP entry in an ARP table as determined by a step 312 (i.e. the ARP response is new), the method then resets switch timer and updates ARP table to include a new ARP entry corresponding to the ARP response at a step 316. Switch timers may be set for any interval. Typically, timers are set for less than 300 seconds. The frame may then be processed at a step 320 whereupon the method ends.

If the ARP response has a corresponding ARP entry in an ARP table as determined by a step 312 (i.e. the ARP response is not new), the method then compares both the MAC address and the associated IP address of the ARP response with the MAC address and the associated IP address of a corresponding ARP entry in an ARP table at a step 324. If a match is found at a step 328, the method then processes the frame a step 320 whereupon the method ends. A match indicates that the ARP response was a legitimate ARP response. If a match is not found at a step 328, an incident is logged at a step 332. A non-match indicates that the ARP response was not a legitimate ARP response.

Turning briefly to FIG. 2, typically, a network does not allow duplicate IP addresses. One skilled in the art can appreciate that allowing duplicate IP addresses in a network would quickly disrupt normal network services. Thus duplicate IP addresses discovered on a network typically result in disruption of network services. However, no such prescription generally applies to duplicate MAC addresses. Thus, if rogue CPU 204 issues a counterfeit ARP response having a counterfeit MAC address, switch 108 will not generally disallow the counterfeit MAC address. This is due in part to a commonly accepted network behavior in accepting the last ARP response containing a MAC address (i.e. renewing an ARP entry) as a legitimate address. At least one reason to allow an ARP entry to renewal to allow access for users who travel between wireless connection points. This accepted network behavior allows a user's service to be continued as he travels across wireless connection ports. In this manner, more efficient data sharing may be accomplished.

However, using methods described herein, a counterfeit ARP response from rogue device may be discovered. Thus, if a rogue device attempts to overcome a legitimate device with a counterfeit ARP response, then the method, in detecting duplicate MAC addresses will then examine the IP address of counterfeit ARP response to determine whether or not a legitimate device is simply changing ports or if a new, different device is attempting to enter the network as a rogue device. By challenging an ARP response in this manner, rogue device attacks may be deterred.

Returning to FIG. 3, as noted above, an incident may be logged at a step 332. Incident logs may contain relevant information including, for example, originating port, time, date, and MAC address being counterfeited. The method then drops the frame at a step 336 and may optionally send an alert at a step 340. Alerts may be configured in accordance with user preferences. In some embodiments, an email may be generated for a network administrator. In other embodiments, service may be denied until an administrator initiates a specific action. The method then ends.

While this invention has been described in terms of several embodiments, there are alterations, permutations, and equivalents, which fall within the scope of this invention. It should also be noted that there are many alternative ways of implementing the methods and apparatuses of the present invention. For example, although steps 332 and 336 are illustrated in a particular order, no such limitation in order is intended. That is, those steps may be accomplished in any order. It is therefore intended that the following appended claims be interpreted as including all such alterations, permutations, and equivalents as fall within the true spirit and scope of the present invention.

What is claimed is:

1. A method of processing an address resolution protocol (ARP) response in connection with a data control switch comprising:
receiving an ARP response, the ARP response having an ARP response MAC address and a corresponding ARP response IP address; and
dropping the ARP response when:
the ARP response MAC address matches any of a plurality of ARP entry MAC addresses residing in an ARP table, and
the corresponding ARP response IP address does not match a corresponding ARP entry IP address.

2. The method of claim 1 further comprising:
creating an ARP entry corresponding to the ARP response in the ARP table when:
the ARP response MAC address does not match any of the plurality of ARP entry MAC addresses.

3. The method of claim 1 further comprising:
processing the ARP response when:
the ARP response MAC address matches any of the plurality of ARP entry MAC address, and
the corresponding ARP response IP address matches the corresponding ARP entry IP address.

4. The method of claim 1 further comprising sending an alert in response to the dropping the ARP response.

5. The method of claim 1 wherein the ARP response is a gratuitous ARP response.

6. The method of claim 1 further comprising:
logging an event in response to the dropping the ARP response.

7. The method of claim 6 wherein the logging the event comprises:
storing a flag type entry;
storing a designated port entry; and
storing a timestamp entry for the event.

8. A method of controlling a network switch comprising:
receiving an ARP response, the ARP response having an ARP response MAC address and a corresponding ARP response IP address; and
dropping the ARP response when:
the ARP response MAC address matches any of a plurality of ARP entry MAC addresses residing in an ARP table, and
the corresponding ARP response IP address does not match a corresponding ARP entry IP address.

9. The method of claim 8 further comprising:
creating an ARP entry corresponding to the ARP response in the ARP table when:
the ARP response MAC address does not match any of the plurality of ARP entry MAC addresses.

10. The method of claim 8 further comprising:
processing the ARP response when:
the ARP response MAC address matches any of the plurality of ARP entry MAC address, and
the corresponding ARP response IP address matches the corresponding ARP entry IP address.

11. The method of claim 8 further comprising sending an alert in response to the dropping the ARP response.

12. The method of claim 8 wherein the ARP response is a gratuitous ARP response.

13. The method of claim 8 further comprising logging an event in response to the dropping the ARP response.

14. The method of claim 13 wherein the logging the event comprises:
storing a flag type entry;
storing a designated port entry; and
storing a timestamp entry for the event.

15. A security enhanced network switch device comprising:
a memory component comprising at least an ARP table for storing a plurality of ARP entries each ARP entry having an ARP entry media access control (MAC) address and a corresponding ARP entry internet protocol (IP) address; and
an address resolution protocol (ARP) component for examining an ARP response frame, the ARP response frame having an ARP response address and a corresponding ARP response IP address.

16. The device of claim 15 wherein the ARP component is configured to reject the ARP response frame when:
the ARP response MAC address matches the ARP entry MAC address; and
the corresponding ARP response IP address does not match the corresponding ARP entry IP address.

17. The device of claim 15 wherein the ARP component is further configured to process the ARP response frame when:
the ARP response MAC address matches the ARP entry MAC address; and
the corresponding ARP response IP address matches the corresponding ARP entry IP address.

18. The device of claim 15 wherein the ARP component is further configured to create a new ARP entry corresponding to the ARP response frame in the ARP table when:
the ARP response MAC address does not match the ARP entry MAC address.

19. A computer program product for use in conjunction with a computer system for processing an address resolution protocol (ARP) response in connection with a data control switch, the computer program product comprising a computer readable storage medium and a computer program mechanism embedded therein, the computer program mechanism comprising:
instructions for receiving an ARP response, the ARP response having an ARP response MAC address and a corresponding ARP response IP address; and
instructions for dropping the ARP response when:
the ARP response MAC address matches any of a plurality of ARP entry MAC addresses residing in an ARP table, and
the corresponding ARP response IP address does not match a corresponding ARP entry IP address.

20. The computer program product of claim 19 further comprising:
instructions for creating an ARP entry corresponding to the ARP response in the ARP table when:
the ARP response MAC address does not match any of the plurality of ARP entry MAC addresses.

21. The computer program product of claim 19 further comprising:
instructions for processing the ARP response when:
the ARP response MAC address matches any of the plurality of ARP entry MAC address, and
the corresponding ARP response IP address matches the corresponding ARP entry IP address.

22. The computer program product of claim 19 further comprising instructions for sending an alert in response to the dropping the ARP response.

23. The computer program product of claim 19 wherein the ARP response is a gratuitous ARP response.

24. The computer program product of claim 19 further comprising:
instructions for logging an event in response to the dropping the ARP response.

25. The computer program product of claim 24 wherein the logging the event comprises:
instructions for storing a flag type entry;
instructions for storing a designated port entry; and
instructions for storing a timestamp entry for the event.
